(19) United States
(12) Patent Application Publication
(10) Pub. No.: US 2008/0262124 A1
(43) Pub. Date: Oct. 23, 2008

(54) Master Batch for Resin

(76) Inventors: Kenji Kimura, Osaka (JP); Yoshinori Sada, Chiba (JP)

Correspondence Address: FOLEY AND LARDNER LLP;SUITE 500, 3000 K STREET NW, WASHINGTON, DC, 20007, US

(21) Appl. No.: 11/884,783

(22) PCT Filed: Feb. 25, 2005
(86) PCT No.: PCT/JP2005/003654

§ 371 Date: Aug. 21, 2007

(51) Int. Cl. C08J 3/22

(52) U.S. Cl. 523/351

(57) ABSTRACT

A process for the production of polyolefin or polystyrene resin compositions, characterized by kneading together a polyolefin or polystyrene resin and a master batch for polyolefin or polystyrene resins which comprises 100 parts by weight of a polyolefin or polystyrene resin, (A) 1.5 to 100 parts by weight of a compound represented by the general formula (1) in claim (such as 6-[3-(3-t-butyl-4-hydroxy-5-methylphenyl)propoxy]-2,4,8,10-tetra-t-butyldibenzo[d,f][1,3,2]dioxaphosphepin) and (B) 0.01 to 1 part by weight of a hydrotalcite compound and/or (C) 0.01 to 1 part by weight of a salt of a fatty acid with a Group II metal of the periodic table; and the above master batch.

### TECHNICAL FIELD

The present invention relates to a master batch for polyolefin or polystyrene-based resin, containing an antioxidant and excellent in preservation stability, and to a method for producing a polyolefin or polystyrene-based resin composition using this master batch.

### BACKGROUND TECHNOLOGY

Japanese Patent Application Laid-Open (JP-A) No. 2002-146121 describes a polyethylene resin composition characterized by containing 0.01 to 1 part by weight of an antioxidant having a phosphate structure and a hindered phenol structure in the same molecule, 0.01 to 1 part by weight of a hydrotalcite type compound and/or 0.01 to 1 part by weight of a salt of II metal in the periodic table of higher fatty acid, based on 100 parts by weight of a polyethylene resin (see, claims). JP-A No. 10-273494 (see, claims and the like) discloses a resin composition containing, based on 100 parts by weight of an organic material, 0.05 to 0.15 parts by weight of a phosphorus-based stabilizer preventing thermal degradation or oxidative degradation of the organic material, and 0.05 parts by weight of calcium stearate or 1 part by weight of a hydrotalcite (see, examples described in paragraphs 110 to 121). Such a resin composition is produced by dry-blending a desired stabilizer in given amount into a resin powder before melt-kneading.

### DISCLOSURE OF THE INVENTION

The composition for master batch resin of the present invention is excellent in preservation stability, and even if used after preservation for a long period of time, the polyolefin or polystyrene-based resin composition to be produced does not get deteriorated stability against thermal oxidation and the like, thus, the composition for master batch resin is industrially advantageous.

That is, the present invention relates, in a first embodiment, to a method for producing a polyolefin or polystyrene-based resin composition characterized by containing kneading a polyolefin or polystyrene-based resin with a master batch for polyolefin or polystyrene-based resin containing

100 parts by weight of a polyolefin or polystyrene-based resin,

(A) 1.5 to 100 parts by weight of a compound of the formula (1):

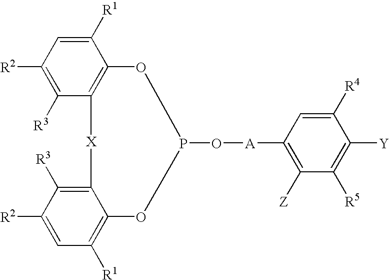

[wherein, R¹, R², R⁴ and R⁵ represent each independently a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group.

R³ represents a hydrogen atom or an alkyl group having 1 to 8 carbon atoms. X represents a single bond, sulfur atom or —CHR⁶— group. R⁶ represents a hydrogen atom, an alkyl group having 1 to 8 carbon atoms or a cycloalkyl group having 5 to 8 carbon atoms. A represents an alkylene group having 2 to 8 carbon atoms or *—COR⁷— group.

The carbon-carbon bond in the above-mentioned alkylene group having 2 to 8 carbon atoms may be interrupted by an oxygen atom, sulfur atom, —NH—, —OCO— or —COO—.

R⁷ represents a single bond or an alkylene group having 1 to 8 carbon atoms, and * indicates bonding to an oxygen atom of a phosphorous acid residue.

One of Y and Z represents a hydroxyl group, an alkoxy group having 1 to 8 carbon atoms or an aralkyloxy group having 7 to 12 carbon atoms, and another mark represents a hydrogen atom or an alkyl group having 1 to 8 carbon atoms.

When Y represents a hydroxyl group, one of R⁴ and R⁵ represents an alkyl group having 3 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group.] and

any one of

(B) 0.01 to 1 part by weight of a hydrotalcite type compound or

(C) 0.01 to 1 part by weight of a salt of II metal in the periodic table of higher fatty acid, or both (B) and (C), and in a second embodiment, to the master batch for polyolefin or polystyrene-based resin.

### BEST MODES FOR CARRYING OUT THE INVENTION

As the polyolefin or polystyrene which can be used in the master batch for polyolefin or polystyrene-based resin of the present invention (hereinafter, referred to as “master batch of the present invention”), and as the polyolefin or polystyrene-based resin suitable for compounding with this master batch, for example, the following resins are exemplified.

(1) homopolymers, block copolymers and random copolymers of ethylene, propylene, vinyl acetate, alpha-olefin, MMA and the like, or copolymers composed of three or more monomers selected from these monomers

(2) homopolymers and block copolymers of styrene, acrylonitrile, butadiene, isoprene, MMA and the like, or copolymers composed of three or more monomers selected from these monomers, or mixtures of these polymers

As the polyolefin or polystyrene-based resin for producing the master batch of the present invention, the above-exemplified resins can be used singly or in admixture.

Polymers using ethylene and propylene, or styrene, are used more suitably.

Specifically, resins such as polyethylene (for example, high density polyethylene (HD-PE), low density polyethylene (LD-PE), linear lower density polyethylene (LLDPE)) and polypropylene (for example, homo, block copolymer, random copolymer, terpolymer), ethylene/vinyl acetate copolymer (EVA), ethylene/methyl methacrylate copolymer (EMMA), acrylonitrile/butadiene/styrene copolymer (ABS), high-impact polystyrene (HI-PS), general purpose polystyrene (GP-PS), styrene/isoprene/butadiene copolymer (SIBS), styrene/butadiene block copolymer (SBS), styrene/isoprene copolymer (SIS), methacrylate/styrene copolymer (MS), acrylonitrile/styrene copolymer (AS) and the like are preferably used in the present invention. The method for producing the above-mentioned polyolefin or polystyrene-based resin is not particularly restricted, and those produced by known methods can be used.

Among the above-mentioned compounds (A) of the formula (1), those in which R¹, R², R⁴ and R⁵ represent each independently a methyl group, t-butyl group, t-pentyl group or t-octyl are preferably used.

Those in which R³ represents a hydrogen atom or methyl group are preferable. Those in which X represents a single bond, methylene or ethylidene are preferable. A represents preferably an alkylene group having 2 to 4 carbon atoms or *—COR⁷— group.

When the carbon-carbon bond in the above-mentioned alkylene group having 2 to 4 carbon atoms is interrupted in mid-course, —OCO— or —COO— is preferable. R⁷ represents preferably an alkylene group having 1 to 4 carbon atoms. * indicates bonding to an oxygen atom of a phosphorous acid residue. When Y represents a hydroxyl group, it is preferable that Z represents a hydrogen atom or methyl group and one of R⁴ and R⁵ represents a t-butyl group.

When Z represents a hydroxyl group, it is preferable that R⁵ represents a methyl group, Y represents a hydrogen atom, and R⁴ represents a t-butyl group.

Of these compounds of the formula (1), particularly preferable specific compounds are exemplified below.
6-[3-(3-t-butyl-4-hydroxy-5-methylphenyl)propoxy]-2,4,8,10-tetra-t-butyldibenz[d,f][1,3,2]dioxaphosphepin [A1], 6-[3-(3,5-di-t-butyl-4-hydroxyphenyl)propoxy]-2,4,8,10-tetra-t-butyldibenz[d,f][1,3,2]dioxaphosphepin, 6-[3-(3,5-di-t-butyl-4-hydroxyphenyl)propoxy]-4,8-di-t-butyl-2,10-dimethyl-12H-dibenzo[d,g][1,3,2]dioxaphosphocin, 6-[3-(3,5-di-t-butyl-4-hydroxyphenyl)propionyloxy]-4,8-di-t-butyl-2,10-dimethyl-12H-dibenzo[d,g][1,3,2]dioxaphosphocin, and the like, are mentioned.

The master batch of the present invention is produced by compounding usually 1.5 parts by weight to 100 parts by weight of a compound of the formula (1) based on 100 parts by weight of a polyolefin or polystyrene-based resin, and compounding amounts of preferably 1.5 parts by weight to 50 parts by weight, more preferably 2 parts by weight to 20 parts by weight are used particularly preferably.

The hydrotalcite type compound to be used in the master batch of the present invention includes hydrotalcite type compounds described in JP-A No. 2002-146121, paragraph 0055, and hydrotalcite type compounds described in JP-A No. 10-273494, paragraph 0050, and the like.

As the particularly preferable hydrotalcite type compounds to be used in the present invention, for example, hydrotalcites represented by the following formula are mentioned.

Mg₁₋ₓAlₓ(OH)₂(CO₃)_{x/2}.pH2O

(wherein, x represents a numerical value of 0 to 0.5, and p represents a numerical value of 0 to 2)

As the hydrotalcite type compound, synthetic hydrotalcite DHT-4A [B1] manufactured by Kyowa Chemical Industry Co., Ltd. is mentioned as a specific example.

The salt of II metal in the periodic table of higher fatty acid to be used in the master batch for polyolefin or polystyrene-based resin of the present invention includes calcium stearate [C1], zinc stearate [C2], magnesium stearate [C3], calcium laurate [C4] and the like.

The hydrotalcite type compounds and the salts of II metal in the periodic table of higher fatty acid in the master batch for polyolefin or polystyrene-based resin of the present invention can be used each singly. These hydrotalcite type compounds and salts of II metal in the periodic table of higher fatty acid may each be used in combination of two or more.

The total use amount of the above-mentioned hydrotalcite type compound and salt of II metal in the periodic table of higher fatty acid is preferably in the range of 0.01 to 1 part by weight based on 100 parts by weight of a polyolefin or polystyrene-based resin, more preferably in the range of 0.05 to 0.5 parts by weight based on 100 parts by weight of a polyolefin or polystyrene-based resin.

Into the master batch of the present invention, if necessary, other neutralizing agents, other antioxidants, photo-stabilizers, lubricants, antistatic agents, pigments, anti-blocking agents and the like can be further compounded to give a composite master batch.

The apparatus and method to be used for production of a master batch of the present invention are not particularly limited providing a compound of the formula (1), a hydrotalcite type compound and/or a salt of II metal in the periodic table of higher fatty acid can be compounded into a polyolefin or polystyrene-based resin before melt kneading by the apparatus and method. Specifically mentioned are, for example, methods in which a polyolefin or polystyrene-based resin, a compound of the formula (1), a hydrotalcite type compound and/or a salt of II metal in the periodic table, and the above-mentioned other antioxidants [for example, phenol-based antioxidants such as stearyl 3-(3,5-di-t-butyl-4-hydroxyphenyl)propionate and the like], photo-stabilizers, lubricants, antistatic agents, pigments, anti-blocking agents and the like to be used if necessary, are previously mixed uniformly by a mixing machine such as a tumbler blender, Henschel mixer or super mixer, then, the mixture is granulated by melt-kneading by a single-screw extruder or multi-screw extruder; methods in which melt-kneading is carried out by a kneader, Banbury mixer and the like, then, granulation is performed using an extruder; and the other methods.

Thus obtained master batch for polyolefin or polystyrene-based resin of the present invention is, due to excellent hydrolysis resistance, capable of preventing matters leading to cost up such as filling of a master batch in a moisture-proof type wrapping material and storage thereof, and even in the case of filling in a wrapping material and storage thereof, the master batch can be preserved also after opening of the wrapping material, thus, there is no need to finish up the master batch at one time. The master batch of the present invention is, usually, stored in a factory depository and the like, then, the master batch of the present invention is compounded into a polyolefin or polystyrene-based resin in accordance with production timing of a polyolefin or polystyrene-based resin article, then, the compound is processed into a desired polyolefin or polystyrene-based resin article by melt-kneading.

In compounding the master batch of the present invention into a polyolefin or polystyrene-based resin, the master batch of the present invention can be used in an amount of X parts by weight based on (100−X) parts by weight of a polyolefin or polystyrene-based resin. X is not particularly restricted providing it is usually in the range of 0 to 100, and from the standpoint of uniform stabilizing effect and economy, X is preferably 0.1 to 33, particularly preferably 0.5 to 10.

The method and apparatus for compounding a master batch of the present invention before use for production of a desired polyolefin or polystyrene-based resin article are not particularly restricted providing a master batch for polyolefin or polystyrene-based resin of the present invention can be compounded, melt-kneaded, then, processed into a desired article by the method and apparatus. Specifically, there are mentioned methods in which, for example, a polyolefin or polystyrene-based resin, a master batch of the present invention, and if necessary, other master batches, for example, a pigment master batch, anti-blocking agent master batch and the like, are previously mixed uniformly by a mixing machine such as, for example, a tumbler mixer, Henschel mixer or super mixer, then, the mixture is melt-kneaded by a single screw extruder or multi screw extruder, and subjected to T die film or inflation film processing, or processed into a molded material and the like by metal molding, and other methods.

### EXAMPLES

The present invention will be illustrated in further detail by reference examples, comparative examples and examples below, but the present invention is not limited to these examples.

### [Production Example of Master Batch for Polyolefin or Polystyrene-Based Resin]

0.8 g of the above-mentioned antioxidant A1 (6-[3-(3-t-butyl-4-hydroxy-5-methylphenyl)propoxy]-2,4,8,10-tetra-t-butyldibenz[d,f][1,3,2]dioxaphosphepin) and 40 mg of the above-mentioned compound C1 (calcium stearate) were weighed correctly and kneaded with 40 g of un-stabilized polyethylene for 3 minutes at a speed of 10 rpm at 160° C. under nitrogen flow using Laboplast mill type C manufactured by Toyo Seiki Seisakusho K.K. The resultant composition was taken out by a spatula, and directly after this, pressed to stretch into a sheet having a thickness of about 1 mm. This sheet was cut into pellets, producing a master batch for polyethylene resin.

### [Evaluation Method for Preservation Stability]

The master batch for resin directly after production obtained in the above-mentioned Production Example and the master batch after preservation at 50° C. under a relative humidity of 80% were subjected to soxhlet extraction, respectively, to extract the antioxidant A1, and the content of the antioxidant in the master batch was analyzed by liquid chromatography. The content of A1 was traced by time when the content of A1 before preservation was 100.

[Production of Resin Composition Using Master Batch after Preservation]

The master batch obtained in the above-mentioned Production Example was preserved for 2 weeks at 50° C. under a relative humidity of 80%, then, 39.2 g of un-stabilized polyethylene, 24 mg of the above-mentioned compound C1 (calcium stearate) and 24 mg of B1 hydrotalcite (hydrotalcite DHT-4A) were weighed correctly and kneaded with 0.8 g of the above-preserved master batch for 3 minutes at a speed of 10 rpm at 160° C. under nitrogen flow using Laboplast mill type C manufactured by Toyo Seiki Seisakusho K.K. The resultant composition was taken out by a spatula, and directly after this, pressed to stretch into a sheet having a thickness of about 1 mm. This sheet was cut into pellets, producing a polyethylene resin composition. The formulation of the polyethylene resin composition produced in this production example is calculated to show that calcium stearate, hydrotalcite and the above-mentioned antioxidant A1 are contained in amounts of 0.06 parts by weight, 0.06 parts by weight and 0.1 part by weight, respectively, based on 100 parts by weight of polyethylene.

### [Evaluation Method for Stability of Resin Composition]

The polyethylene resin composition obtained in the above-mentioned Production Example was left under an air atmosphere at 210° C. and time until initiation of heat generation was measured by DSC. Longer time until initiation of heat generation means higher stability against thermal oxidation (having higher antioxidant performance).

### Examples 1 to 5, Comparative Example 1, and Reference Example 1

In Examples 1 to 5, Comparative Example 1 and Reference Example 1, the master batches produced according to the above-mentioned Production Example were used.

In Tables 1 and 2 describing evaluation of hydrolysis resistance, ratios of polyethylene (PE), antioxidant and compounds added are represented by parts by weight when the amount of polyethylene is 100 parts.

TABLE 1

| | | | | Comparative | Reference |
|---|---|---|---|---|---|
| | | Example 1 | Example 2 | Example 1 | Example 1 |
| PE (parts by | | 100 | 100 | 100 | 100 |
| weight) | | | | | |
| A-1 (parts | | 2 | 2 | 2 | 0.2 |
| by weight) | | | | | |
| C-1 (parts | | 0.1 | | | |
| by weight) | | | | | |
| B-1 (parts | | | 0.1 | | |
| by weight) | | | | | |
| Retention | 2 weeks | 100 | 100 | 16 | 100 |
| (%) | 4 weeks | 96 | 93 | — | 100 |

TABLE 2

| | | Example 3 | Example 4 | Example 5 |
|---|---|---|---|---|
| PE (parts by | | 100 | 100 | 100 |
| weight) | | | | |
| A-1 (parts by | | 5 | 5 | 20 |
| weight) | | | | |
| C-1 (parts by | | 0.1 | 0.1 | 0.1 |
| weight) | | | | |
| B-1 (parts by | | | 0.1 | |
| weight) | | | | |
| Retention | 2 weeks | 100 | 100 | 97 |
| (%) | 4 weeks | 99 | 95 | 99 |

In Examples 6 to 10, Comparative Examples 2 to 3 and Reference Example 2, production was performed according to the above-mentioned production method of resin composition. With regard to resin compositions shown in Table 3, time until initiation of heat generation was measured by DSC according to the above-mentioned evaluation method for stability of resin composition. The results are shown in Table 3.

TABLE 3
(unit of number accompanied by no particular
description is part by weight)

| | | | | | | Example | Comparative | Comparative | Reference |
|---|---|---|---|---|---|---|---|---|---|
| | | Example 6 | Example 7 | Example 8 | Example 9 | 10 | Example 2 | Example 3 | Example 2 |
| Formulation | PE | 100 | 100 | 100 | 100 | 100 | 100 | 100 | 100 |
| of | A1 | 5 | 2 | 2 | 2 | 10 | 5 | 5 | 0.1 |
| MB | C1 | 0.1 | 0.1 | 0.1 | 0.5 | 0.1 | — | 3 | — |
| | B1 | — | — | 0.1 | — | — | — | 3 | — |
| Raw | PE | 98 | 95 | 95 | 95 | 99 | 98 | 97.8 | 0 |
| materials | C-1 | 0.06 | 0.06 | 0.06 | 0.04 | 0.06 | 0.06 | — | 0.06 |
| of PE | B-1 | 0.06 | 0.06 | 0.06 | 0.06 | 0.06 | 0.06 | — | 0.06 |
| article | MB | 2 | 5 | 5 | 5 | 1 | 2 | 2.2 | 100 |
| Formulation | PE | 100 | 100 | 100 | 100 | 100 | 100 | 100 | 100 |
| of | A-1 | 0.1 | 0.1 | 0.1 | 0.1 | 0.1 | 0.1 | 0.1 | 0.1 |
| PE | C-1 | 0.06 | 0.06 | 0.06 | 0.06 | 0.06 | 0.06 | 0.06 | 0.06 |
| article | B-1 | 0.06 | 0.06 | 0.06 | 0.06 | 0.06 | 0.06 | 0.06 | 0.06 |

| | | | | | | | | |
|---|---|---|---|---|---|---|---|---|
| Effect of | 30 | 28 | 21 | 18 | 26 | 6 | 3 | 15 |
| stabilization | | | | | | | | |
| of PE article | | | | | | | | |
| (min) | | | | | | | | |

### Example 11

A master batch for polystyrene resin was produced in the same manner as in Production Example excepting that, in the above-mentioned Production Example for polyolefin-based resin or polystyrene-based resin, polyethylene was changed to GP-PS and the kneading temperature in Laboplast mill was changed to 200° C. A polystyrene resin composition was produced in the same manner excepting that this master batch for polystyrene resin was preserved for 2 hours at 50° C. under a relative humidity of 80%, and the kneading temperature in Laboplast mill in Production Example of resin composition from the above-mentioned master batch after preservation was changed to 200° C. Stability of thus obtained polystyrene resin composition was measured by the same method as for the polyethylene composition.

| | | | | | | | | Stabili- |
|---|---|---|---|---|---|---|---|---|
| | | | | | | | | zation |
| | MB formulation | | | Formulation | | | | effect |
| | of PS | | | of PS article | | | | of PS |
| | PS | A-1 | C-1 | PS | A-1 | B-1 | C-1 | article |
| Example 11 | 100 | 5 | 0.1 | 100 | 0.1 | 0.06 | 0.06 | 54 min |

### INDUSTRIAL APPLICABILITY

The master batch for polyolefin or polystyrene-based resin of the present invention contains specific amount of a compound of the formula (1) and specific amount of one compound selected from hydrotalcite type compounds and/or salts of II metal in the periodic table, therefore, hydrolysis resistance of an antioxidant in the above-mentioned master batch is improved, and even if the master batch directly after production is preserved for a long period of time, its quality is not deteriorated. In the case of use of a master batch after preservation for a long period of time to produce a polyolefin or polystyrene-based resin article, an excellent stabilization effect (antioxidant performance) is shown.

1. A method for producing a polyolefin or polystyrene-based resin composition comprising kneading a polyolefin or polystyrene-based resin with a master batch for polyolefin or polystyrene-based resin containing
100 parts by weight of a polyolefin or polystyrene-based resin,
(A) 1.5 to 100 parts by weight of a compound of the formula (1): 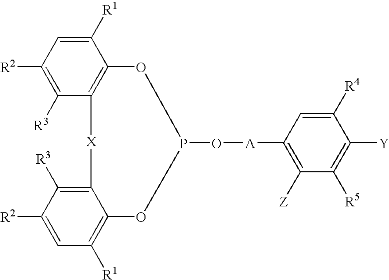
[wherein, R¹, R², R⁴ and R⁵ represent each independently a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group.
R³ represents a hydrogen atom or an alkyl group having 1 to 8 carbon atoms. X represents a single bond, sulfur atom or —CHR⁶— group. R⁶ represents a hydrogen atom, an alkyl group having 1 to 8 carbon atoms or a cycloalkyl group having 5 to 8 carbon atoms. A represents an alkylene group having 2 to 8 carbon atoms or *—COR⁷— group.
The carbon-carbon bond in said alkylene group having 2 to 8 carbon atoms may be interrupted by an oxygen atom, sulfur atom, —NH—, —OCO— or —COO—.
R⁷ represents a single bond or an alkylene group having 1 to 8 carbon atoms, and * indicates bonding to an oxygen atom of a phosphorous acid residue.
One of Y and Z represents a hydroxyl group, an alkoxy group having 1 to 8 carbon atoms or an aralkyloxy group having 7 to 12 carbon atoms, and another mark represents a hydrogen atom or an alkyl group having 1 to 8 carbon atoms.
When Y represents a hydroxyl group, one of R⁴ and R⁵ represents an alkyl group having 3 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group.] and
any one of
(B) 0.01 to 1 part by weight of a hydrotalcite type compound or
(C) 0.01 to 1 part by weight of a salt of II metal in the periodic table of higher fatty acid, or both (B) and (C).

2. The production method according to claim 1 wherein the compound (A) of the formula (1) is 6-[3-(3-t-butyl-4-hydroxy-5-methylphenyl)propoxy]-2,4,8,10-tetra-t-butyldibenz[d,f][1,3,2]dioxaphosphepin.

3. The production method according to claim 1 wherein (C) is calcium stearate.

4. The production method according to claim 1 wherein the master batch is used in an amount of 0.1 to 50 parts by weight based on 100 parts by weight of the polyolefin or polystyrene-based resin.

5. A master batch for polyolefin or polystyrene-based resin according to claim 1.

6. A method for producing a master batch for polyolefin or polystyrene-based resin according to claim 1 comprising kneading
100 parts by weight of a polyolefin or polystyrene-based resin with
(A) 1.5 to 100 parts by weight of a compound of the formula (1): 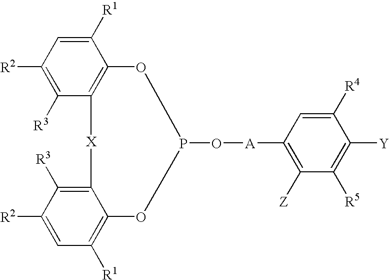
[wherein, R¹, R², R⁴ and R⁵ represent each independently a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group.
R³ represents a hydrogen atom or an alkyl group having 1 to 8 carbon atoms. X represents a single bond, sulfur atom or —CHR⁶— group. R⁶ represents a hydrogen atom, an alkyl group having 1 to 8 carbon atoms or a cycloalkyl group having 5 to 8 carbon atoms. A represents an alkylene group having 2 to 8 carbon atoms or *—COR⁷— group.
The carbon-carbon bond in said alkylene group having 2 to 8 carbon atoms may be interrupted by an oxygen atom, sulfur atom, —NH—, —OCO— or —COO—.
R⁷ represents a single bond or an alkylene group having 1 to 8 carbon atoms, and * indicates bonding to an oxygen atom of a phosphorous acid residue.
One of Y and Z represents a hydroxyl group, an alkoxy group having 1 to 8 carbon atoms or an aralkyloxy group having 7 to 12 carbon atoms, and another mark represents a hydrogen atom or an alkyl group having 1 to 8 carbon atoms.
When Y represents a hydroxyl group, one of R⁴ and R⁵ represents an alkyl group having 3 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group.] and
any one of
(B) 0.01 to 1 part by weight of a hydrotalcite type compound or
(C) 0.01 to 1 part by weight of a salt of II metal in the periodic table of higher fatty acid, or both (B) and (C).
